(19) United States
(12) Patent Application Publication
(10) Pub. No.: US 2014/0260507 A1
(43) Pub. Date: Sep. 18, 2014

(54) PULSE DURATION EXTENDER

(71) Applicant: GENERAL ELECTRIC COMPANY, Schenectady, NY (US)

(72) Inventor: Daniel Zahi Abawi, Gardnerville, NV (US)

(21) Appl. No.: 13/842,450

(22) Filed: Mar. 15, 2013

(51) Int. Cl. G01D 18/00

(52) U.S. Cl. CPC G01D 18/00
USPC 73/1.01

(57) ABSTRACT

A system includes a sensor that is configured to measure an operating parameter of a machine and transmit a signal related to the measured operating parameter. The system also includes a passive signal modification circuit. The passive modification circuit is configured to receive the signal and generate a modified signal based on the received signal. Additionally, the modified signal that is generated has a characteristic that it exceeds a threshold value for an amount of time greater than a second amount of time that the received signal exceeds the threshold value. The passive modification circuit is further configured to control the amount of time that the modified signal exceeds the threshold value.

### BACKGROUND

The subject matter disclosed herein generally relates to the modification of sensed signals based on the duration of the sensed signal.

Monitoring the operation of machinery, such as wind turbines, gas turbines, compressors, motors, generators, and other devices may allow for proactive detection of potential faults. This monitoring may, for example, allow for the planning for maintenance outages and/or early detection of potential faults that may affect the output of the machinery or cause failures in the machinery. As a result, the monitoring may allow for increased availability, improved reliability, and lower overall costs for operating the machinery.

However, problems may exist when the machinery to be monitored does not properly interface with the monitoring equipment utilized to monitor the machinery. For example, signals related to the operation of the machinery may be generated and transmitted to the monitoring equipment. However, these signals may not be properly interpreted (e.g., they may be incorrectly formatted, of a wrong type, or may include other constraints that may lead to incorrect analysis by the monitoring equipment). Accordingly, it would be advantageous to insure that signals generated related to the operation of machinery are properly readable by monitoring equipment (e.g., so that the signals transmitted to the monitoring equipment are able to be read, recorded, and/or operated on).

### BRIEF DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In one embodiment, a system includes a sensor configured to measure an operating parameter of a machine and transmit a signal related to the measured operating parameter, and a passive signal modification circuit configured to receive the signal, generate a modified signal based on the received signal, wherein the modified signal exceeds a threshold value for an amount of time greater than a second amount of time that the received signal exceeds the threshold value, and control the amount of time that the modified signal exceeds the threshold value.

In another embodiment, a device includes a signal path configured to transmit a signal related to operation of a machine and a signal modification circuit coupled to the signal path, wherein the signal modification circuit comprises only passive circuit elements, wherein the signal path is configured to receive the signal, generate a modified signal based on the received signal, wherein the modified signal exceeds a threshold value for an amount of time greater than a second amount of time that the received signal exceeds the threshold value, control the amount of time that the modified signal exceeds the threshold value, and transmit the modified signal.

In a further embodiment, a method includes receiving a signal at a passive signal modification circuit related to operation of a machine, generating at the signal modification circuit a modified signal based on the received signal, wherein the modified signal exceeds a threshold value for an amount of time greater than a second amount of time that the received signal exceeds the threshold value, controlling the amount of time that the modified signal exceeds the threshold value, and transmitting the modified signal from the signal modification circuit.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram view of an embodiment including machinery and monitoring equipment;

FIG. 2 is a timing diagram related to the operation of the machinery and monitoring equipment of FIG. 1;

FIG. 3 is a block diagram view of a second embodiment including the machinery and monitoring equipment of FIG. 1;

FIG. 4 is a timing diagram related to the operation of the machinery and monitoring equipment of FIG. 3, in accordance with an embodiment;

FIG. 5 is a circuit diagram of an embodiment of the pulse extender circuitry of FIG. 3;

FIG. 6 is a circuit diagram of a second embodiment of the pulse extender circuitry of FIG. 3; and

FIG. 7 is a flow chart view illustrating an embodiment of a method related to the operation of the machinery and monitoring equipment of FIG. 3.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, a signal related to an operating parameter of machinery to be monitored may be generated and transmitted. In one embodiment, this signal may be generated by one or more sensors coupled to an element of the machinery to be monitored. The transmitted signal may be received by a signal modification circuit. The signal modification circuit may modify the received signal to generate a modified sensed signal. This modified sensed signal may then be transmitted to a monitor for recording and/or analysis. By modifying the signal received from the machinery (e.g., from a sensor coupled to or part of the machinery), fewer signals transmitted to the monitor may go undetected. In one embodiment, the duration of the received signal may be extended, such that the monitor may have adequate time to recognize the modified sensed signal. This may reduce the number of missed measurements in the monitor, thus allowing for a proper interface between the machinery to be monitored and the monitoring equipment so that the signals received by the monitor are properly interpreted.

Moreover, the signal modification circuitry may be a standalone passive circuit device. That is, the signal modification circuitry may operate without a power source being coupled to the signal modification circuitry (i.e., the signal modification circuitry does not require any additional source of power to perform its function). Additionally, the signal modification circuitry may control the timing of the decay rate of the modified sensed signal. For example, selection of the passive circuitry (e.g., control of an RC time constant) may be chosen to generate a particular result (i.e., extend the duration of a pulse for a predicted amount of time). Furthermore, the signal modification circuitry may be utilized in conjunction with speed detection pulses. That is, the signal modification circuitry may extend pulses related to the speed of a device (e.g., rotational speed of a shaft). These and other embodiments are described in greater detail below.

FIG. 1 illustrates a block diagram view of an embodiment of machinery 10 to be monitored as well as a monitor 12 that may monitor one or more operating parameters of the machinery 10. In certain embodiments, the machinery 10 may be representative of one or more of the following: wind turbines, steam turbines, hydraulic turbines, gas turbines, aeroderivative turbines, compressors, gears, turbo-expanders, centrifugal pumps, motors, generators, fans, blowers, agitators, mixers, centrifuges, pulp refiners, ball mills, crushers/pulverizers, extruders, pelletizers, cooling towers/heat exchanger fans, and/or other systems suitable to be monitored. In one embodiment, the machinery 10 may be a wind or a gas turbine with a shaft 14.

During operation of the machinery, the shaft 14 may rotate. Additionally, as illustrated, the shaft 14 may include an event marker 16 that rotates in conjunction with the shaft 14. Thus, as the shaft rotates, the event marker 16 may pass one or more sensors 18, whereby the sensor 18 may record that the event marker 16 has passed the sensor 18. Moreover, every time the event marker 16 passes the sensor 18, a signal indicative of the speed of the rotation of the shaft 14 may be generated by the sensor 18. However, it is noted that this is merely one embodiment and sensor 18 may record additional or alternate information related to the operation of machinery 10. In some embodiments, event marker 16 may be, for example, a notch, a projection, or any other indication that indicates that the shaft 14 has rotated. Additionally, more than one event marker 16 may be present on the shaft 14 to allow for multiple detections to occur for each rotation of the shaft 14.

In one embodiment, the machinery 10 may include one or more sensors 18 in an enclosure of the machinery 10. In another embodiment, the one or more sensors 18 may be coupled to the machinery 10 but may be in a separate enclosure from the machinery 10. The sensors 18 may be transducers or other suitable measurement devices, which can be used to measure various parameters of the machinery 10 or components therein, for example, the rotational speed of shaft 14. In some embodiments, the sensor 18 may include an eddy current/proximity sensor, a magnetic pickup sensor, an electronic switch/encoder, or other suitable measuring devices. In various embodiments, as described above, the sensor 18 may generate a signal indicative of an operating parameter of the machinery 10 (e.g., the rotational speed of shaft 14). The sensor 18 may transmit the signal related to the operating parameter of machinery 10 to be monitored along signal path 20.

In one embodiment, signal path 20 may be a wired or a wireless connection that may include a communication channel, such as an Ethernet connection and/or the like. For example, transmitter 22 may be a port that couples to signal path 20, whereby signal path 20 may be a cable or other transmission medium. In another embodiment, transmitter 22 may be a wireless transmitter or transceiver that may provide communication via a wireless network, such as a local area network (LAN) (e.g., Wi-Fi), a wide area network (WAN) (e.g., 3G or 4G), Bluetooth network, or another wireless network as the signal path 20.

The signal indicative of the performance of the operation of one or more elements of the machinery 10 may be transmitted along signal path 20 to monitor 12. In some embodiments, the monitor 12 may include an instrumentation system that may allow for proactive detection of potential faults. The monitor 12 may be a monitoring system similar to or may be, for example, a 3500 Series Machinery Protection System with Bently Nevada™ Asset Condition Monitoring made available by General Electric® of Schenectady, N.Y., a 3700 Series Machinery Protection System with Bently Nevada™ Asset Condition Monitoring (ADAPT.WIND) made available by General Electric® of Schenectady, N.Y., or a similar system.

In one embodiment, the illustrated monitor 12 may include a terminal 24 that may be coupled to the signal path 20 (e.g., the terminal 24 may be a physical input port or a wireless transceiver). The monitor 12 may also include one or more display indicators 26 that may indicate the operational status of the monitor 12, as well as other characteristics of the monitor 12. For example, the status indicators 26 may indicate that the monitor 12 is powered on. The indicators 26 may additionally and/or alternatively display information representing a status of the monitored machinery 10 (e.g., standby, alarms, etc.). In certain embodiments, one or more of the indicators 26 may represent whether there is a fault in the monitored machinery 10, the monitor 12, the sensor 18, the signal path 20, or in additional circuitry coupled to the monitor 12.

In some embodiments, the monitor 12 may receive the signal indicative of measured operating parameters of the machinery 10 (e.g., the signal transmitted along signal path 20) and may record and/or analyze the signal indicative of measured operating parameters of the machinery 10. For example, the monitor 12 may display on a display (e.g., a display integrated in the monitor) operating parameters of the machinery 10 that are generated based on the received signal along path 20. This information additionally and/or alternatively may be transmitted to a workstation (e.g., a computer) for viewing by a user that may be coupled to the monitor 12 via a physical connection and/or wirelessly.

In some embodiments, the signal indicative of measured operating parameters of the machinery 10 (e.g., the signal transmitted along signal path 20) may be related to the rotation speed of shaft 14. FIG. 2 illustrates a timing diagram related to the sensing performed by sensor 18. Graph 28 is illustrated in FIG. 2 and represents time versus voltage. At a time 30, the event marker 16 may rotate past the sensor 18, causing a pulse 32 to be generated by the sensor 18. This pulse 32 may have a duration 34 of a set amount of time (e.g., the time a signal is at or above a particular threshold, such as a voltage). In some embodiments, this duration 34 may be approximately 1 microsecond (μs), 2 μs, 3 μs, 4 μs, 5 μs, 6 μs, 7 μs, 8 μs, 9 μs, 10 μs, or another value. Thus, a pulse 32 of a particular voltage may be generated by the sensor 18 for a duration 34 of time, whereby the pulse 32 is indicative of the event marker 16 passing the sensor 18. Similarly, at a second time 36, the event marker 16 may rotate past the sensor 18 (e.g., a second revolution of the shaft 14 may occur), which causes a pulse 38 to be generated by the sensor 18. This pulse 38 may be similar in duration 34 to pulse 32, i.e., the duration 34 of pulse 38 may be approximately 1 microsecond (μs), 2 μs, 3 μs, 4 μs, 5 μs, 6 μs, 7 μs, 8 μs, 9 μs, 10 μs, or another value. Thus, each time the event marker 16 passes the sensor 18, a signal (e.g., pulse 32 and pulse 38) indicative of the speed of the rotation of the shaft 14 may be generated. However, it is noted that this is merely one embodiment and sensor 18 may record additional or alternate information related to the operation of machinery 10. As previously discussed, event marker 16 may be a notch, a projection, or any other indication that indicates that the shaft 14 has rotated and more than one event marker 16 may be present on the shaft 14 to allow for multiple detections to occur for each rotation of the shaft 14 (e.g., pulse 32 and pulse 38 may each correspond to a separate event marker 16 as a shaft 14 completes one revolution).

In the manner described above, pulses 32 and 38 may be generated, as well as transmitted, singularly or as part of a pulse stream along signal path 20 to monitor 12 for analysis and/or recording of a characteristic of the machinery 10 (here, the rotational speed of shaft 14). However, pulses 32 and 38 may be too short of a duration 34 for the monitor 12 to effectively receive. That is, the monitor 12 may include circuitry that identifies that the pulses 32 and 38 have been received. However, this circuitry may miss pulses 32 and/or 38 (e.g., fail to recognize the reception of pulses 32 and/or 38) when their duration 34 is relatively short (e.g., 10 μs or less). The monitor 12 instead may register pulses more successfully when the duration 34 of the pulses 32 and 38 is extended (e.g., greater than 10 μs).

Accordingly, FIG. 3 illustrates a second embodiment whereby the signal path 20 between machinery 10 and monitor 12 includes a signal modification circuit 40. In one embodiment, the signal modification circuit 40 may operate to increase a duration 34 of the signal transmitted along signal path 20. In one embodiment, the signal modification circuit 40 may be formed as a part of signal path 20. For example, if signal path 20 is a physical connection between the machinery 10 and the monitor 12, the signal modification circuit 40 may be housed in a common enclosure or housing with, for example, a cable or wire in the signal path 20. Alternatively, the signal modification circuit 40 may be electrically coupled to the signal path 20 in a distinct housing or enclosure from the signal path 20. In other embodiments, the signal modification circuit 40 may be formed as part of the sensor 18 (e.g., in a common housing or enclosure with sensor 18). The signal modification circuit 40 may, alternatively, be electrically coupled to the sensor 18, for example, between the sensor 18 and the transmitter 22 in housing of the machinery 10. Still further, the signal modification circuit 40 may be part of monitor 12 (e.g., in a common housing or enclosure with monitor 12).

Each of the locations described above for the signal modification circuit 40 may have particular advantages. For example, when the signal modification circuit 40 is part of the signal path 20, (e.g., in a common housing with signal path 20 or electrically coupled thereto), replacement of the signal modification circuit 40 may be easier than when the signal modification circuit 40 is part of the machinery 10 or monitor 12. Additionally, when the signal modification circuit 40 is part of the signal path 20, the design of the monitor 12 and machinery 10 may be simplified. Moreover, when the signal modification circuit 40 is part of the signal path 20, the signal modification circuit 40 may be moved between multiple locations (e.g., between various machinery and monitors separate from machinery 10 and monitor 12). Likewise, when the signal modification circuit 40 is part of either the sensor 18, located between the sensor 18 and the transmitter 22, wirelessly coupled to both the transmitter 22 and the monitor 12, or is physically in the monitor 12, wireless transmission of signal path 20 may be accomplished with a modified signal still being processed by the monitor 12. This may be advantageous, for example, when it would be difficult and/or costly to run a physical signal path 20 between the machinery 10 and the monitor 12.

In some embodiments, the signal modification circuit 40 may be a standalone passive circuit device. That is, the signal modification circuit 40 may operate without a power source being coupled to the signal modification circuitry 40 (i.e., the signal modification circuitry 40 does not require any additional source of power to perform its function). Additionally, the signal modification circuit 40 may operate to modify the signal generated by sensor 18 to generate a modified sensed signal. This modified sensed signal may, for example, alter a duration 34 of the received signal 32 and 38 (e.g., extend the time a received signal is at or above a particular threshold) in a controlled manner (e.g., for a set period of time). FIG. 4 illustrates a timing diagram related to generating a modified sensed signal that extends the time the modified sensed signal is at or above a particular threshold, here, a particular voltage threshold relative to the signal generated by sensor 18.

FIG. 4 illustrates a graph 42 of time versus voltage that illustrates the output of the of the signal modification circuit 40. The signal modification circuit 40 may receive a signal, such as pulse 32 along signal path 20. The signal modification circuit 40 may then modify that signal (e.g., pulse 32) to alter the characteristics of the received signal (e.g., pulse 32). For example, the signal modification circuit 40 may generate a modified sensed signal 44. This modified sensed signal 44 may have a duration 46 (an amount of time) above a threshold (e.g., a particular voltage level) that exceeds the duration 34 of the received signal (e.g., pulse 32). In one embodiment, the duration 46 (the amount of time) that the modified sensed signal 44 exceeds a threshold value may be approximately 10 μs, 12 μs, 14 μs, 16 μs, 18 μs, 20 μs, 25 μs, 30 μs, or another value. The duration 46 (the amount of time) that the modified sensed signal 44 exceeds a threshold value may also be expressed as a multiple of the duration 34 of the received signal (e.g., pulse 32), for example, two times, three times, four times, five times, or another value larger than the duration 34 of the received signal (e.g., pulse 32).

Similarly, as the signal modification circuit 40 receives a second signal, such as pulse 38 along signal path 20, the signal modification circuit 40 may modify that second signal (e.g., pulse 38) to alter the characteristics of the second received signal (e.g., pulse 38). For example, the signal modification circuit 40 may generate a second modified sensed signal 48. This modified sensed signal 48 may have a duration 50 (an amount of time) above a threshold (e.g., a particular voltage level) that exceeds the duration 34 of the received signal (e.g., pulse 38). In one embodiment, the duration 50 (the amount of time) that the modified sensed signal 48 exceeds a threshold value may be approximately 10 μs, 12 μs, 14 μs, 16 μs, 18 μs, 20 μs, 25 μs, 30 μs, or another value. The duration 50 (the amount of time) that the modified sensed signal 48 exceeds a threshold value may also be expressed as a multiple of the duration 34 of the second received signal, for example, two times, three times, four times, five times, or another value larger than the duration 34 of the second received signal (e.g., pulse 38).

In this manner, modified sensed signals 44 and 48 may be generated by the signal modification circuit 40. The modified sensed signals 44 and 48 may each correspond to a single rotation of the shaft 14 or, in some embodiments, they may correspond to a single rotation of the shaft (e.g., when two event markers 16 are present on shaft 14). In one embodiment, these modified sensed signals 44 and 48 may also be transmitted from the signal modification circuit 40 to the monitor 12 either singularly, or as part of a pulse stream, along signal path 20 to monitor 12 for analysis and/or recording of the characteristic of the machinery 10 (e.g., the rotational speed of shaft 14). Moreover, as the modified sensed signals 44 and 48 have had their durations 46 and 50 extended (relative to duration 34), the monitor 12 can effectively receive and process the modified sensed signals 44 and 48. Thus, the monitor 12 may be able to register received signals more successfully than if signals (e.g., pulses 32 and 38) with a duration 34 are received.

As discussed above, the signal modification circuit 40 may alter received signals to generate modified sensed signals 44 and 48. FIG. 5 illustrates one embodiment of circuitry of the signal modification circuit 40 that may be utilized to alter received signals to generate modified sensed signals 44 and 48. Signal modification circuit 40 may include an input 52 and an output 54. The input 52 may receive signals from the sensor 18 (e.g., pulses 32 and 38). Similarly, output 54 may transmit modified sensed signals 44 and 48, for example, to monitor 12, for example, either directly via signal path 20 or through transmitter 22. The signal modification circuit 40 may also include a diodes 56 and 58, capacitor 60, and resistor 62. Thus, the signal modification circuit 40 may include only passive circuitry (i.e., circuit elements that do not require any power source to perform their function). In this manner, the signal modification circuit 40 is a passive circuit.

The diode 56 of the signal modification circuit 40 may be positioned in a forward direction to allow current to flow generally from the input 52 to the output 54 of the signal modification circuit 40, while the diode 58 may be positioned in a reverse direction to prevent current from flowing generally from the input 52 to the output 54 of the signal modification circuit 40. Thus, when the voltage at input 52 exceeds the turn-on voltage of the diode 56 (e.g., approximately 0.7 V), the diode 56 will transmit current and an accompanying voltage to output 54 as well as to capacitor 60 to charge the capacitor 60. For example, as a signal is received (e.g., pulse 32) at the input 52, the voltage of that signal will be transmitted both to the capacitor 60 as well as to output 54. During the time that the received signal is “high” (e.g., at a positive voltage), the capacitor 60 will be charged. This charging may correspond to the duration 34 of the pulse 32 and/or 38.

Additionally, when the signal ceases to be present at input 52 (e.g., pulse 32 ends and the voltage at input 52 drops to 0), capacitor 60 will begin to discharge the voltage stored therein, for example, through resistor 62, diode 58, diode 56, and to output 54. This has the effect of extending the amount of time that the output 54 is transmitting a voltage. For example, as previously discussed with respect to FIG. 4, the output 54 of the signal modification circuit 40 may be a voltage that exceeds a threshold voltage for approximately 10 μs, 12 μs, 14 μs, 16 μs, 18 μs, 20 μs, 25 μs, 30 μs, or another value. Moreover, it is noted that the time of discharge may be set by selecting values for the capacitor 60 and the resistor 62 that cause a discharge to path to maintain a voltage at output 54 for a desired period of time. That is, through control of the RC constants of the signal modification circuit 40, the decay rate of modified sensed signals 44 and 48 (e.g., the amount of time that duration 46 and duration 50, respectively, exceed a threshold (e.g., a particular voltage level)) may be controlled.

In this manner, the signal modification circuit 40 may control the modified sensed signals 44 and 48 (e.g., control the extending of the duration 34 of received pulses 32 and 38). Alteration of the control of an amount of time that a modified signal (e.g., modified sensed signals 44 and 48) exceeds a threshold value may be advantageous because the signal modification circuit 40 can be set to operate with various monitors 12. That is, by controlling, for example, the RC constants of the signal modification circuit 40, the decay rate of modified sensed signals 44 and 48 may be tuned for use with particular monitors 12.

While utilization of a circuit (such as that illustrated in FIG. 5), which has the diode 58 in series with resistor 62 may occur, it is understood that the circuit arrangement of the signal modification circuit 40 may be altered. For example, FIG. 6 illustrates a circuit arrangement of the signal modification circuit 40 that may include the diode 58 in parallel with the resistor 62. Signal modification circuit 40 of FIG. 6 may operate is substantially the same manner as the signal modification circuit 40 of FIG. 5. For example, the signal modification circuit 40 of FIG. 6 may be utilized to generate modified sensed signals 44 and 48. Signal modification circuit 40 may include an input 52 and an output 54. The input 52 may receive signals from the sensor 18 (e.g., pulses 32 and 38). Similarly, output 54 may transmit modified sensed signals 44 and 48, for example, to monitor 12, for example, either directly via signal path 20 or through transmitter 22. The signal modification circuit 40 may also include a diodes 56 and 58, capacitor 60, and resistor 62. Thus, the signal modification circuit 40 may include only passive circuitry (i.e., circuit elements that do not require any source of energy to perform their function). In this manner, the signal modification circuit 40 is a passive circuit.

As illustrated, the signal modification circuit 40 of FIG. 6 includes a diode 56 that may be positioned in a forward direction to allow current to flow generally from the input 52 to the output 54 of the signal modification circuit 40, while the diode 58 may be positioned in a reverse direction to prevent current from flowing generally from the input 52 to the output 54 of the signal modification circuit 40. Thus, when the voltage at input 52 exceeds the turn-on voltage of the diode 56 (e.g., approximately 0.7 V), the diode 56 will transmit current and an accompanying voltage to output 54 as well as to capacitor 60 to charge the capacitor 60. For example, as a signal is received (e.g., pulse 32) at the input 52, the voltage of that signal will be transmitted both to the capacitor 60 as well as to output 54. During the time that the received signal is “high” (e.g., at a positive voltage), the capacitor 60 will be charged. This charging may correspond to the duration 34 of the pulse 32 and/or 38.

Additionally, when the signal ceases to be present at input 52 (e.g., pulse 32 ends and the voltage at input 52 drops to 0), capacitor 60 will begin to discharge the voltage stored therein, for example, through resistor 62 to output 54. This has the effect of extending the amount of time that the output 54 is transmitting a voltage. For example, as previously discussed with respect to FIG. 4, the output 54 of the signal modification circuit 40 may be a voltage that exceeds a threshold voltage for approximately 10 μs, 12 μs, 14 μs, 16 μs, 18 μs, 20 μs, 25 μs, 30 μs, or another value. Moreover, it is noted that the time of discharge may be set by selecting values for the capacitor 60 and the resistor 62 that cause a discharge to path to maintain a voltage at output 54 for a desired period of time. That is, through control of the RC constants of the signal modification circuit 40, the decay rate of modified sensed signals 44 and 48 (e.g., the amount of time that duration 46 and duration 50, respectively, exceed a threshold (e.g., a particular voltage level)) may be controlled. In this manner, the signal modification circuit 40 may control the modified sensed signals 44 and 48 (e.g., control the extending of the duration 34 of received pulses 32 and 38). As noted above, alteration of the control of an amount of time that a modified signal (e.g., modified sensed signals 44 and 48) exceeds a threshold value may be advantageous because the signal modification circuit 40 can be set to operate with various monitors 12. That is, by controlling, for example, the RC constants of the signal modification circuit 40, the decay rate of modified sensed signals 44 and 48 may be tuned for use with particular monitors 12. Moreover, while two embodiments of the signal modification circuit 40 have been outlined above, it may be appreciated that alternative circuits may be utilized to generate the modified sensed signals 44 and 48 and the configuration present in FIGS. 5 and 6 is not meant to be exclusive of other circuit configurations.

Operation of the signal modification circuit 40 may further be illustrated with respect to FIG. 7. FIG. 7 illustrates a flow chart 64 that details a method related to the operation of the signal modification circuit 40. For example, a signal (e.g., pulse 32) is received by the signal modification circuit 40 in step 66 from the sensor 18. This signal (e.g., pulse 32) is modified in step 68, whereby a modified signal (e.g., modified sense signal 44) based on the received signal (e.g., pulse 32) is generated. For example, this modification may include extending the duration (e.g., duration 34) of the received signal (e.g., pulse 32) so that the modified signal (e.g., modified sense signal 44) to be transmitted is transmitted for a greater period of time (duration 46) relative to the duration (e.g., duration 34) of the received signal (e.g., pulse 32). In step 70, the signal modification circuit 40 may transmit the modified signal (e.g., modified sense signal 44). As previously noted, the modified signal (e.g., modified sense signal 44) may differ in at least one characteristic from the received signal (e.g., pulse 32). For example, the amount of time (duration 46) that the modified signal (e.g., modified sense signal 44) exceeds a threshold may be greater than the amount of time (duration 34) that the received signal (e.g., pulse 32) exceeds that same threshold.

Technical effects of the invention include reception and modification of a signal, wherein the received and modified signal may be related to an operating parameter of machinery to be monitored. The modified signal may also be transmitted to a monitor for analysis. The received signal may be generated by one or more sensors coupled to an element of machinery to be monitored. By modifying the received signal prior to its transmission to a monitor, greater accuracy in reception of the modified signal may be achieved, relative to transmitting the signal directly from the sensor (e.g., without modification of the signal) to the monitor. The modification of the signal, in some embodiments, may include extending the amount of time that the signal meets or exceeds a threshold value.

Additionally, the signal modification circuitry that modifies the received signals may be a standalone passive circuit device that operates without any power source coupled thereto. Moreover, the signal modification circuitry may control the timing of the decay rate of the modified sense signal based on the control of the internal elements of the signal modification circuitry. For example, an RC constant of the signal modification circuitry may be set to a particular level to control the decay rate of the modified signal. Furthermore, the signal modification circuitry may be utilized in conjunction with speed detection pulses that may, for example, relate to a speed measurement of a portion of a device (e.g., a rotational speed of a shaft). Through use of the signal modification circuitry, the duration of a received signal (e.g., pulse) may be extended.

This written description uses examples to disclose the above description, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a sensor configured to measure an operating parameter of a machine and transmit a signal related to the measured operating parameter; and
a passive signal modification circuit configured to:
receive the signal;
generate a modified signal based on the received signal, wherein the modified signal exceeds a threshold value for an amount of time greater than a second amount of time that the received signal exceeds the threshold value; and
control the amount of time that the modified signal exceeds the threshold value.

2. The system of claim 1, wherein the sensor is configured to measure the operating parameter via determining whether at least one event marker interfaces with the sensor.

3. The system of claim 1, comprising a monitor configured to receive and analyze the modified signal.

4. The system of claim 3, comprising a signal path, wherein the signal path is physically coupled to the monitor, wherein the signal modification circuit is configured to transmit the modified signal along the signal path.

5. The system of claim 4, comprising a housing, wherein the housing comprises both the signal path and the signal modification circuit.

6. The system of claim 3, comprising a housing, wherein the housing comprises both the monitor and the signal modification circuit.

7. The system of claim 3, comprising a transmitter configured to receive the modified signal from the signal modification circuit and wirelessly transmit the modified signal to the monitor.

8. The system of claim 1, comprising a housing, wherein the housing comprises both the sensor and the signal modification circuit.

9. The system of claim 1, wherein the signal modification circuit comprises a capacitor coupled to a resistor, wherein the capacitor and resistor operate in conjunction to generate the modified signal.

10. A device, comprising:
a signal path configured to transmit a signal related to operation of a machine; and
a signal modification circuit coupled to the signal path, wherein the signal modification circuit comprises only passive circuit elements, wherein the signal path is configured to:
receive the signal;
generate a modified signal based on the received signal, wherein the modified signal exceeds a threshold value for an amount of time greater than a second amount of time that the received signal exceeds the threshold value;
control the amount of time that the modified signal exceeds the threshold value; and
transmit the modified signal.

11. The device of claim 10, comprising a housing, wherein the housing comprises both the signal path and the signal modification circuit.

12. The device of claim 10, comprising a first housing comprising the signal path and a second housing comprising the signal modification circuit.

13. The device of claim 10, wherein the signal modification circuit comprises a capacitor in parallel with a resistor, wherein the capacitor and resistor operate in conjunction to generate the modified signal.

14. The device of claim 10, wherein the signal path comprises a first port configured to interface with the machine.

15. The device of claim 14, wherein the signal path comprises a second port configured to interface with a monitor.

16. The device of claim 10, wherein the signal path comprises a first port configured to interface with a sensor coupled to the machine.

17. A method, comprising:
receiving a signal at a passive signal modification circuit related to operation of a machine;
generating at the signal modification circuit a modified signal based on the received signal, wherein the modified signal exceeds a threshold value for an amount of time greater than a second amount of time that the received signal exceeds the threshold value;
controlling the amount of time that the modified signal exceeds the threshold value; and
transmitting the modified signal from the signal modification circuit.

18. The method of claim 17, comprising:
measuring via a sensor an operating parameter of the machine;
generating via the sensor the signal based on the measured operating parameter; and
transmitting the signal from the sensor.

19. The method of claim 18, wherein measuring an operating parameter comprises determining rotational speed of a shaft as the operating parameter of the machine.

20. The method of claim 17, comprising generating the modified signal through interaction between a capacitor coupled to a resistor present in the signal modification circuit.
